(19) United States
(12) Patent Application Publication
(10) Pub. No.: US 2012/0048305 A1
(43) Pub. Date: Mar. 1, 2012

(54) Loose Fiber Cleaning Apparatus and Process

(76) Inventor: William V. Alcini, Ann Arbor, MI (US)

(21) Appl. No.: 12/868,956

(22) Filed: Aug. 26, 2010

(51) Int. Cl. B08B 5/00

(52) U.S. Cl. 134/34; 15/405

(57) ABSTRACT

A method and apparatus for cleaning an exhaust treatment device including a fibrous insulation comprises providing a pulsed air flow to a first port of the exhaust treatment device. A vibration is input to the exhaust treatment device while the pulsed air flow is provided. Fibers are entrained in the air flow and purged from a second port of the exhaust treatment device.

### FIELD

The present disclosure generally relates to the assembly of exhaust treatment devices. More particularly, the present disclosure provides an apparatus and process for purging loose fibers of insulation from the exhaust treatment device.

### BACKGROUND

Exhaust gas treatment devices such as catalytic converters, diesel oxidation catalysts, diesel particulate filters, and the like are employed in various applications to physically and/or catalytically treat exhaust gases emitted from internal combustion engines. Many of the gas treatment devices include a substrate that may include a catalyst coating. In one configuration, the substrate may be surrounded by a mat of compressible fibrous material prior to being inserted into a housing compartment of the gas treatment device.

Fibrous mat is typically provided in sheet form or in a roll that is cut to size to surround the appropriate substrate. Loose fibers may be formed during the mat cutting operation, the subsequent handling of the catalyst and mat, and during the time when the mat and substrate are being inserted into the housing. Depending on the location of the loose fibers, these fibers may become entrained in the exhaust gas stream and engage surfaces of the substrate or other downstream exhaust treatment devices.

Other exhaust treatment devices include fibrous insulation positioned between inner and outer shells. Portions of the insulation are often exposed to the exhaust gas stream. Fibers of insulation may be loosened during the exhaust treatment device assembly process. Accordingly, there may be a need for an apparatus and process to remove loose fibers from recently assembly exhaust treatment devices.

### SUMMARY

This section provides a general summary of the disclosure, and is not a comprehensive disclosure of its full scope or all of its features.

A method for cleaning an exhaust treatment device including a fibrous insulation comprises providing a pulsed air flow to a first port of the exhaust treatment device. A vibration is input to the exhaust treatment device while the pulsed air flow is provided. Fibers are entrained in the air flow and purged from a second port of the exhaust treatment device.

An apparatus for cleaning an exhaust gas treatment device includes a source of air flow. An air flow chopper is in receipt of air from the source and is adapted to supply air pulses to the exhaust gas treatment device. A vibration device is adapted to provide a vibration to the gas treatment device while the air pulses flow through the gas treatment device to dislodge and purge loose fibers from the exhaust gas treatment device.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a cross-sectional view of an exemplary exhaust treatment device; and

FIG. 2 is a schematic depicting an apparatus for purging loose fibers from an exhaust gas treatment device.

Corresponding reference numerals indicate corresponding parts throughout the several views of the drawings.

### DETAILED DESCRIPTION

Example embodiments will now be described more fully with reference to the accompanying drawings.

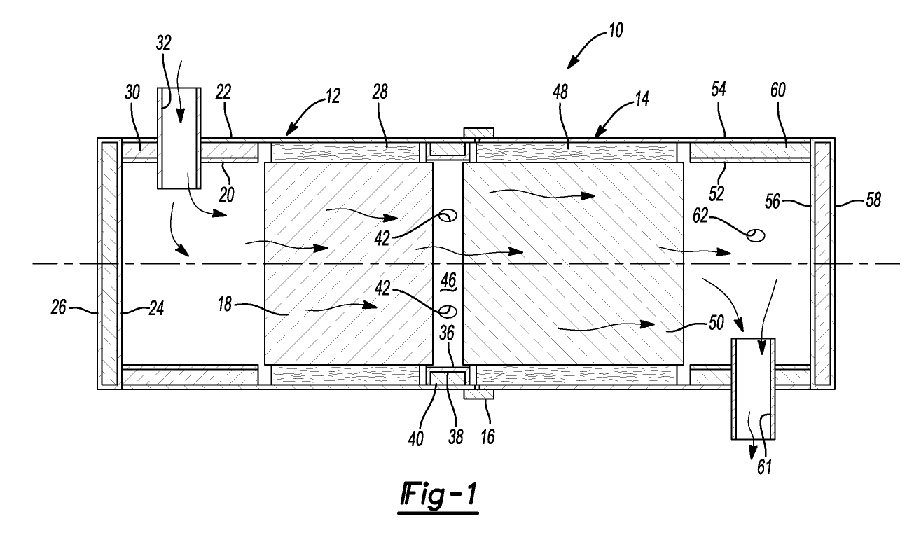

FIG. 1 depicts an exemplary exhaust treatment device identified at reference numeral 10. Exhaust treatment device 10 includes a diesel oxidation catalyst assembly (DOC assembly) 12 coupled to a diesel particulate filter assembly (DPF assembly) 14 with a clamp 16. DOC assembly 12 includes a ceramic substrate 18, an inner shell 20, an outer shell 22, an inner end plate 24 and an outer end plate 26. A fibrous mat 28 surrounds substrate 18 and is positioned between an outer surface of substrate 18 and an inner surface of outer shell 22. Insulation 30 is positioned between inner shell 20 and outer shell 22 as well as between inner end plate 24 and outer end plate 26. An inlet 32 extends through outer shell 22 and inner shell 20 to provide a passageway for exhaust to enter exhaust treatment device 10.

An insulator ring 36 defines a channel 38 in receipt of insulation 40. A plurality of apertures 42 extend through insulator ring 36 to allow sensors (not shown) to extend into a cavity 46 positioned downstream of substrate 18.

DPF assembly 14 includes a mat 48, a filter element 50, an inner housing 52, an outer housing 54, an inner head plate 56 and an outer head plate 58. A fibrous insulation 60 is positioned between inner housing 52 and outer housing 54 as well as between inner head plate 56 and outer head plate 58. An outlet 61 extends through outer housing 54 and inner housing 52 at a position downstream from filter element 50. Another sensor aperture 62 extends through outer housing 54 and inner housing 52 for receipt of a downstream sensor (not shown). When exhaust treatment device 10 is mounted to a vehicle, engine exhaust flows into inlet 32, through substrate 18, through cavity 46, through filter element 50 and exits at outlet 61.

Mat 28, mat 48, insulation 30 and insulation 40 may be constructed from relatively brittle fibers that may break off from a sheet during initial cutting of the material, handling and/or installation into outer shell 22.

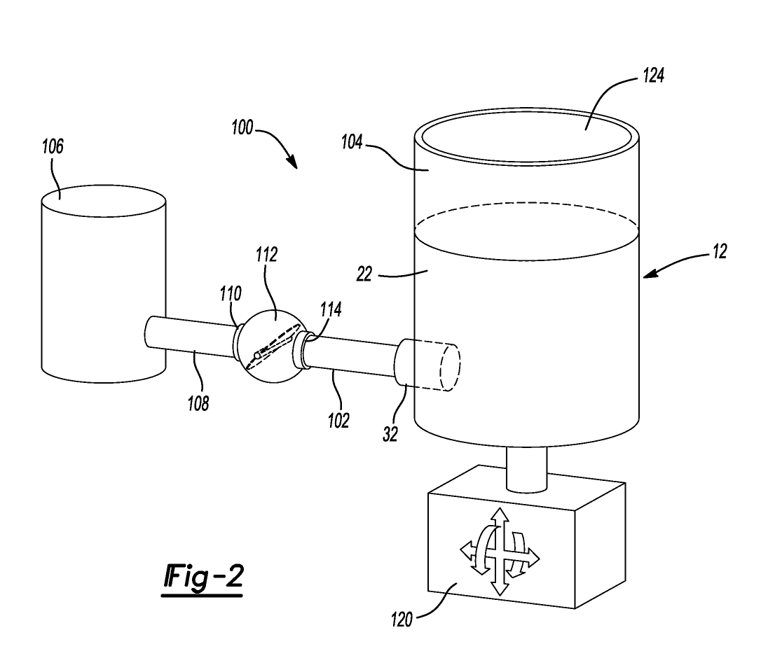

FIG. 2 depicts a cleaning apparatus 100 for removing loose insulation fibers and dust that may be contained within DOC assembly 12 after the DOC sub-assembly process has been completed. Prior to interconnecting DOC assembly 12 with DPF assembly 14, a cleaning process is performed. Inlet 32 is coupled to a conduit 102. Outer shell 22 is coupled to a baffle 104. Baffle 104 is sized and shaped to direct the gas flow to and increase the flow velocity around apertures 42 and insulator ring 36. Baffle 104 may restrict flow from a predetermined area in a cross section downstream of the device being cleaned so as to modify the air flow pattern within the device being cleaned. In the arrangement depicted in FIG. 2, baffle 104 forces the flow around apertures 42 at higher flow velocities as compared to when a baffle is not present. In many cases, such a baffle device can be used to alter the flow path and simulate downstream components at a reduced cost or create a smaller cleaner package space.

Cleaning apparatus 100 includes a source of air flow 106. It is contemplated that the airflow source provides clean air at ambient temperature. The entire cleaning apparatus 100 including air flow source 106 may be portable to allow positioning at different locations along the exhaust treatment device assembly line. A conduit 108 provides air flow to an inlet 110 of a flow chopper 112. An outlet 114 of flow chopper 112 is in fluid communication with conduit 102. Flow chopper 112 functions to vary the flow rate output at outlet 114. Flow chopper 112 may be configured using a variety of structures including a rotating butterfly valve, a flapper valve and actuator combination, a ball valve and actuator combination, or any number of mechanical elements that may selectively restrict and unrestrict flow through flow chopper 112. It is further contemplated that the flow rate exiting outlet 114 may range from a magnitude 30% greater than the maximum estimated flow rate through exhaust treatment device during vehicular operation to a minimum as low as zero. Other maximum and minimum values may also be set as long as a pulse of air is input to inlet 32. Depending on the geometry of the flow chopper, the pulsed air input to DOC assembly 12 may be substantially shaped as a square wave or more closely represent a sinusoidal wave.

Apparatus 100 also includes a vibration device 120 fixed to DOC assembly 12. Vibration device 120 is operable to excite DOC assembly 12 to move loose insulation fibers and dust relative to outer shell 22. Vibration device 120 may include impact hammers to impart a vibration to outer shell 22. Alternatively or additionally, vibration device 120 may include a shaker assembly operable to displace outer shell 22 relative to the ground. The shaker assembly may be operable to translate and/or rotate outer shell 22 along multiple translation and rotational axes.

In operation, cleaning apparatus 100 supplies pressurized air from flow source 106 through conduit 108 to flow chopper 112. Flow chopper 112 provides a pulsed air output to DOC assembly 12. As the pulsed air flows through DOC assembly 12, vibration device 120 adds energy to outer shell 22 to displace loose fibers and entrain them within the air flowing through substrate 18. During the cleaning process, the loose fibers exit DOC assembly 12 and enter baffle 104. Baffle 104 includes an outlet 124 allowing the loosened fibers and dust to exit the cleaning apparatus. It is contemplated that the cleaning process may be completed in one minute or less. Once the loose fibers and dust have been purged from DOC assembly 12 it is decoupled from conduit 102 and baffle 104 for assembly to DPF assembly 14.

It should be appreciated that cleaning apparatus 100 may be useful for removing fibers and dust from other types of exhaust treatment devices including diesel particulate filters, selective catalytic reduction substrates, ammonia slip catalysts, or other exhaust treatment devices. Furthermore, while the exhaust treatment device shown in FIG. 1 includes a DOC upstream of a DPF, other arrangements of exhaust treatment devices may also be treated with cleaning apparatus 100. Multiple exhaust treatment devices may be positioned in series, parallel or series-parallel arrangements without departing from the scope of the present disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for cleaning an exhaust treatment device including a fibrous insulation, the method comprising:
providing a pulsed air flow to a first port of the exhaust treatment device;
inputting a vibration to the exhaust treatment device while the pulsed air flow is being provided;
entraining fibers into the air flow; and
purging fibers from a second port of the exhaust treatment device.

2. The method of claim 1 wherein providing a pulsed air flow includes supplying pressurized air to a flow chopper.

3. The method of claim 2 wherein the flow chopper includes a rotary butterfly valve.

4. The method of claim 1 further including coupling a flow restriction device to the second port of the exhaust treatment device.

5. The method of claim 4 further including selectively restricting flow in a predetermined area of the exhaust treatment device to increase a flow in another area of the exhaust treatment device.

6. The method of claim 1 wherein the exhaust treatment device includes a diesel oxidation catalyst substrate wrapped by a fibrous mat, the loose fibers travelling through the substrate during the cleaning process.

7. The method of claim 6 further including coupling a diesel particulate filter to the diesel oxidation catalyst after the purging step has been completed.

8. The method of claim 1 wherein the pulsed air flow travels through the exhaust treatment device in the same direction during the cleaning process as in operation.

9. An apparatus for cleaning an exhaust gas treatment device, comprising:
a source of air flow;
an air flow chopper in receipt of air from the source, the air flow chopper adapted to supply air pulses to the exhaust gas treatment device; and
a vibration device adapted to provide a vibration to the gas treatment device while the air pulses flow through the gas treatment device to dislodge and purge loose fibers from the exhaust gas treatment device.

10. The cleaning apparatus of claim 9 wherein the source of air flow is portable to be positioned at one of a number of positions along an exhaust gas treatment device assembly line.

11. The cleaning apparatus of claim 9 wherein the flow chopper includes a rotary butterfly valve.

12. The cleaning apparatus of claim 9 wherein the pulse of air supplied by the flow chopper cyclically varies between a maximum air flow rate and a minimum air flow rate.

13. The cleaning apparatus of claim 12 wherein the maximum air flow rate is 30% greater than a maximum flow rate passing through the exhaust gas treatment device during operation.

14. The cleaning apparatus of claim 13 wherein the minimum flow rate is substantially zero.

15. The cleaning apparatus of claim 9 further including a flow restrictor adapted to be coupled to the exhaust gas treatment device at a downstream location to simulate an air flow under operating conditions.

16. The cleaning apparatus of claim 15 wherein the flow restrictor is adapted to restrict air flow through a predetermined portion of the exhaust gas treatment device to increase air flow through a different portion of the exhaust gas treatment device.

17. The cleaning apparatus of claim 9 wherein the vibration device is operable to translate and rotate the exhaust gas treatment device.

18. The cleaning apparatus of claim 9 wherein the air flow chopper is adapted to supply air pulses to a diesel oxidation catalyst to purge loose fibers therefrom.
